(19) United States
(12) Patent Application Publication
(10) Pub. No.: US 2012/0168391 A1
(43) Pub. Date: Jul. 5, 2012

(54) ADJUSTMENT MODULE OF A PROJECTOR

(75) Inventor: Kuang-Yao Liu, Hsin-Chu (TW)

(73) Assignee: CORETRONIC CORPORATION, Hsin-Chu (TW)

(21) Appl. No.: 13/293,143

(22) Filed: Nov. 10, 2011

(30) Foreign Application Priority Data
Dec. 31, 2010 (CN) 201010623337.X

(51) Int. Cl. G03B 21/54

(52) U.S. Cl. 211/26

(57) ABSTRACT

An adjustment module adapted to a projector includes first and second racks, a screw, a rotary knob, a pin, and an elastic member. The first rack fixed to the projector has a first opening. The second rack is pivotally connected to the first rack and has a second opening. The screw is configured between the first rack and the second rack. The rotary knob has a threaded hole. One end of the screw passes through the first opening and is screwed into the threaded hole. The other end of the screw passes through the second opening and is fixed to the pin. The first rack and the second rack are located between the rotary knob and the pin. The elastic member is configured between the first rack and the second rack. The elastic member pushes the first rack against the rotary knob and pushes the second rack against the pin.

### CROSS-REFERENCE TO RELATED APPLICATION

This application claims the priority benefit of China application serial no. 201010623337.X, filed on Dec. 31, 2010. The entirety of the above-mentioned patent application is hereby incorporated by reference herein and made a part of this specification.

### BACKGROUND OF THE INVENTION

1. Field of the Invention

The invention relates to an adjustment module, and more particularly, to an adjustment module adapted to a projector.

2. Description of Related Art

A projector is a display apparatus for producing a large-dimension frame. According to an imaging principle of the projector, an illuminative beam generated by a light source module is converted into an image beam by a light valve, and the image beam passes through the lens and is projected onto a screen or a wall. With recent advancement in projection techniques and reduction in manufacturing costs of projectors, the projectors have been gradually applied for commercial use and even household use.

In a hanging-type projector, an adjustment module can be configured between the ceiling and the projector for adjusting the angle at which the projector is placed and for eliminating keystone-like distortion and inclination of the projected image. One of the well-known adjustment modules on the market is a rotary mechanism that is comprised of a ball joint or three hinges for adjusting the angle at which the projector is placed. In order to change the angle at which the projector is placed, said adjustment module requires manual adjustment of the projector, and then screws are tightened, which causes extreme inconvenience to users and is rather time-consuming.

In Taiwan patents Nos. 214268, M270301, and M272012, hanging structures for adjusting the inclined angle at which the projector is placed are respectively disclosed. Taiwan patent No. I234050 discloses a wall-mounting apparatus for a projector. In this patent, a reflective mirror whose angle is adjustable reflects the projection light of the projector to the screen. Taiwan patent No. M308356 discloses a hanging structure for a projector. In this patent, the angle at which the projector is placed can be adjusted at wide-angle position.

### SUMMARY OF THE INVENTION

An embodiment of the invention is directed to an adjustment module capable of adjusting an angle at which a projector is placed.

Other features and advantages of the invention can be further illustrated by the technical features broadly embodied and described as follows.

In an embodiment of the invention, an adjustment module adapted to a projector is provided. The adjustment module includes a first rack, a second rack, a first screw, a first rotary knob, a first pin, and a first elastic member. The first rack is suitable for being fixed to the projector and has a first opening. The second rack is pivotally connected to the first rack along a first axis and has a second opening. The first screw is configured between the first rack and the second rack. The first rotary knob has a first threaded hole. One end of the first screw passes through the first opening and is screwed into the first threaded hole. The other end of the first screw passes through the second opening and is fixed to the first pin. The first rack and the second rack are located between the first rotary knob and the first pin. The first elastic member is configured between the first rack and the second rack. The first elastic member pushes the first rack against the first rotary knob and pushes the second rack against the first pin. When the first rotary knob rotates and moves toward the second rack along the first screw, the first rack is driven to resist a resilient force of the first elastic member and pivot relative to the second rack. When the first rotary knob rotates and moves away from the second rack along the first screw, the first elastic member releases the resilient potential energy and pushes the first rack to pivot relative to the second rack.

In the adjustment module, the first elastic member is a compression spring, and the first screw passes through the compression spring.

In the adjustment module, a length of the second opening is greater than an outer diameter of the first screw, and the first screw moves along the second opening when the first rack pivots relative to the second rack.

The adjustment module further includes a third rack, a second screw, a second rotary knob, a second pin, and a second elastic member.

The third rack is pivotally connected to the second rack along a second axis that is perpendicular to the first axis. The second rack further has a third opening, and the third rack has a fourth opening.

The second screw is configured between the second rack and the third rack.

The second rotary knob has a second threaded hole, and one end of the second screw passes through the fourth opening and is screwed into the second threaded hole.

The other end of the second screw passes through the third opening and is fixed to the second pin, and the second rack and the third rack are located between the second rotary knob and the second pin.

The second elastic member is configured between the second rack and the third rack, and the second elastic member pushes the second rack against the second pin and pushes the third rack against the second rotary knob.

In the adjustment module, the second elastic member is a compression spring, and the second screw passes through the compression spring.

In the adjustment module, a length of the third opening is greater than an outer diameter of the second screw, and the second screw moves along the third opening when the third rack pivots relative to the second rack.

The adjustment module further includes a fourth rack, a third screw, a third rotary knob, a third pin, and a third elastic member.

The fourth rack is pivotally connected to the third rack along a third axis that is perpendicular to the first axis and the second axis. Besides, the fourth rack has a fifth opening, and the fourth rack is suitable for being fixed to a fixing end.

The third rotary knob has a third threaded hole.

One end of the third screw passes through the fifth opening and is screwed into the third threaded hole, and the other end of the third screw has a restraining portion and a pivoting hole. The fourth rack is located between the third rotary knob and the restraining portion.

The third pin is fixed to the third rack and pivotally connected to the pivoting hole.

The third elastic member is configured between the fourth rack and the restraining portion.

In the adjustment module, the third elastic member is a compression spring, and the third screw passes through the compression spring.

In the adjustment module, the fourth rack includes a main body and a side board.

The main body is pivotally connected to the third rack along the third axis.

The side board is connected to the main body and is perpendicular to the main body. The fifth opening is formed at the side board, and the side board is located between the third rotary knob and the restraining portion. The third elastic member is configured between the side board and the restraining portion.

In the adjustment module, the main body has a sixth opening. One end of the third pin passes through the sixth opening and is pivotally connected to the pivoting hole. A length of the sixth opening is greater than an outer diameter of the third pin. The third pin moves along the sixth opening when the fourth rack pivots relative to the third rack.

In the adjustment module, the third rack has a pivoting portion. The main body is pivotally connected to the pivoting portion along the third axis and has at least one sliding slot. The adjustment module further includes at least one locking member passing through the sliding slot. The locking member is locked to the pivoting portion and moves along the sliding slot when the main body rotates relative to the pivoting portion along the third axis.

In the adjustment module, the third pin is pivotally connected to the pivoting hole along a fourth axis, and the fourth axis is parallel to the third axis.

As described in the previous embodiments of the invention, the first elastic member pushes the first rack against the first rotary knob and pushes the second rack against the first pin, so as to fix the relative angle of the first and second racks. When the angle at which the projector is placed is to be adjusted, the first rotary knob can be rotated to move along the first screw, such that the first rack is driven to compress the first elastic member and pivot relative to the second rack, or the compressed first elastic member releases the resilient potential energy to pivot the first rack relative to the second rack, so as to fine tune the angle at which the projector fixed to the first rack is placed.

Other features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a three-dimensional view illustrating an adjustment module according to an embodiment of the invention.

FIG. 2 is a cross-sectional view illustrating some components in the adjustment module depicted in FIG. 1.

FIG. 3A is a three-dimensional view illustrating that the first rack depicted in FIG. 1 pivots relative to the second rack.

FIG. 3B is a three-dimensional view illustrating that the first rack depicted in FIG. 1 pivots relative to the second rack from another viewing angle.

FIG. 4 is a cross-sectional view illustrating some components in the adjustment module depicted in FIG. 1.

FIG. 5A is a three-dimensional view illustrating that the third rack depicted in FIG. 1 pivots relative to the second rack.

FIG. 5B is a three-dimensional view illustrating that the third rack depicted in FIG. 1 pivots relative to the second rack from another viewing angle.

FIG. 6 is a partial side view illustrating the adjustment module depicted in FIG. 1.

FIG. 7 is an explosive view illustrating partial components of the adjustment module depicted in FIG. 1.

FIG. 8 is a side view illustrating the adjustment module depicted in FIG. 1.

FIG. 9 is a cross-sectional view illustrating the adjustment module depicted in FIG. 1.

FIG. 10 is a partial top view illustrating the adjustment module depicted in FIG. 1.

### DESCRIPTION OF EMBODIMENTS

In the following detailed description of the embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

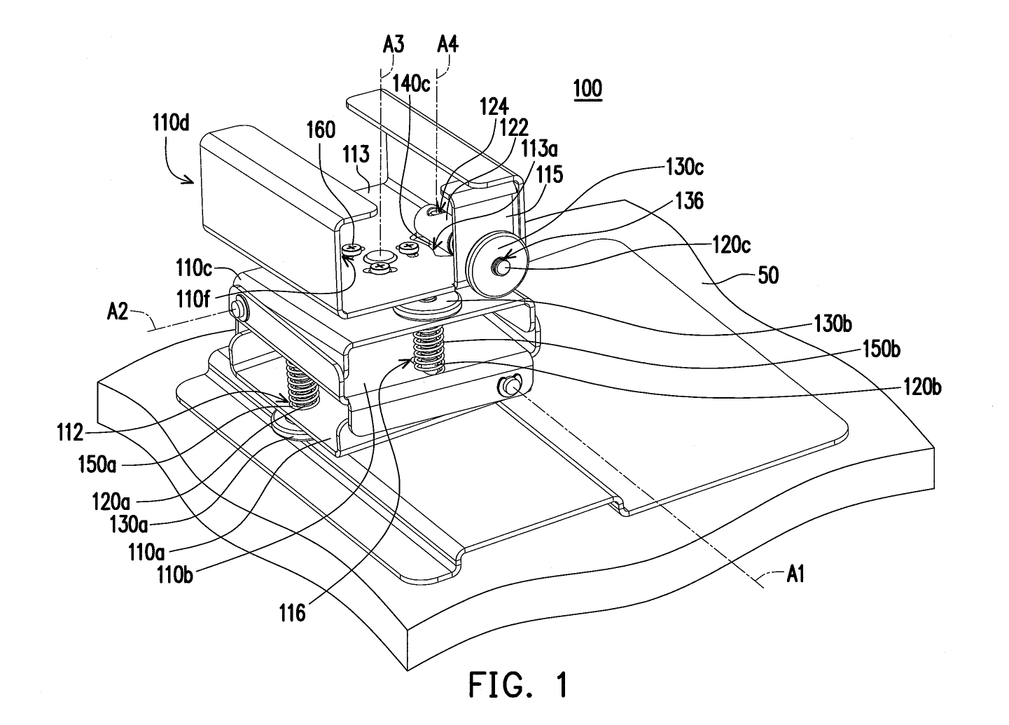

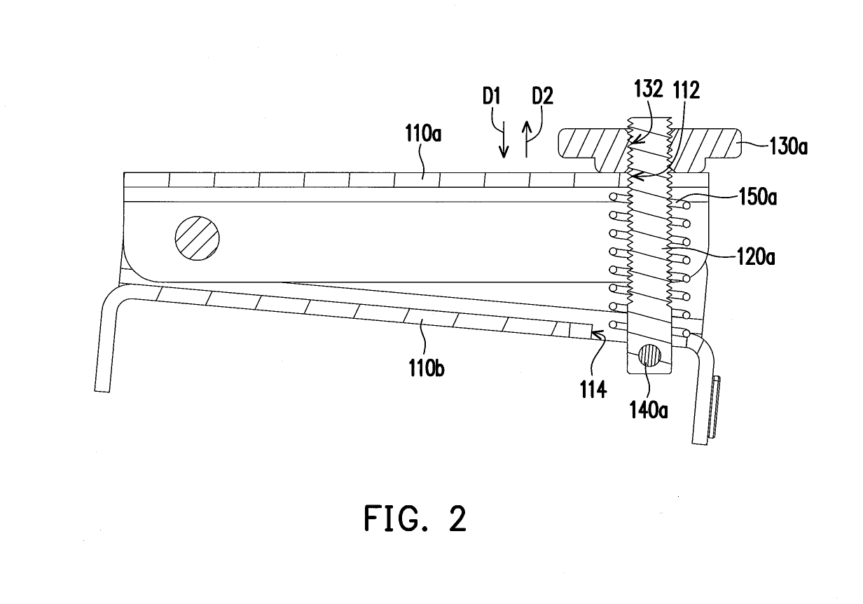

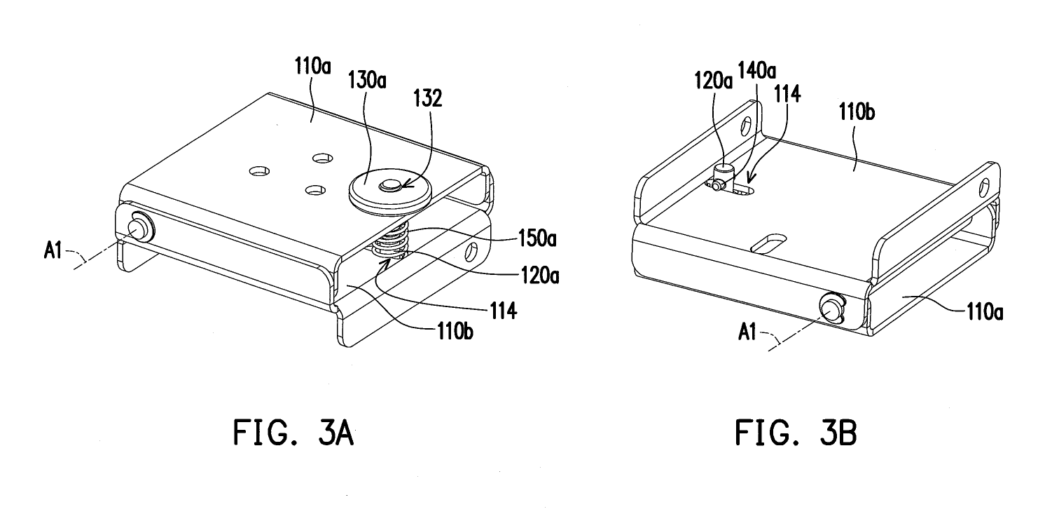

FIG. 1 is a three-dimensional view illustrating an adjustment module according to an embodiment of the invention. FIG. 2 is a cross-sectional view illustrating partial components in the adjustment module depicted in FIG. 1. FIG. 3A is a three-dimensional view illustrating that the first rack depicted in FIG. 1 pivots relative to the second rack. FIG. 3B is a three-dimensional view illustrating that the first rack depicted in FIG. 1 pivots relative to the second rack from another viewing angle. With reference to FIG. 1, FIG. 2, FIG. 3A, and FIG. 3B, the adjustment module 100 of this embodiment includes a first rack 110a, a second rack 110b, a first screw 120a, a first rotary knob 130a, a first pin 140a, and a first elastic member 150a.

The first rack 110a is suitable for being fixed to a projector 50 and has a first opening 112. The second rack 110b is pivotally connected to the first rack 110a along a first axis Al and has a second opening 114. The first screw 120a is configured between the first rack 110a and the second rack 110b. The first rotary knob 130a has a first threaded hole 132. One end of the first screw 120a passes through the first opening 112 and is screwed into the first threaded hole 132. The other end of the first screw 120a passes through the second opening 114 and is fixed to the first pin 120a. The first rack 110a and the second rack 110b are located between the first rotary knob 130a and the first pin 120a. The first elastic member 150a is configured between the first rack 110a and the second rack 110b. Besides, the first elastic member 150a pushes the first rack 110a against the first rotary knob 130a and pushes the second rack 110b against the first pin 140a. Moreover, in this embodiment, the first elastic member 150a is, for example, a compression spring, and the first screw 120a passes through the compression spring.

When the first rotary knob 130a rotates and moves toward the second rack 110b along the first screw 120a, i.e., moves along the direction D1 shown in FIG. 2, the first rack 110a is driven to resist a resilient force of the first elastic member 150a and pivots relative to the second rack 110b, such that the relative angle of the first rack 110a and second rack 110b is shown from the position of FIG. 1 and FIG. 2 to the position of FIG. 3A and FIG. 3B. When the first rotary knob 130a rotates and moves away from the second rack 110b along the first screw 120a, i.e., moves along the direction D2 shown in FIG. 2, the first elastic member 150a releases the resilient potential energy and pushes the first rack 110a to pivot relative to the second rack 110b, such that the relative angle of the first rack 110a and second rack 110b is shown from the position of FIG. 3A and FIG. 3B to the postion of FIG. 1 and FIG. 2. The length of the second opening 114 is designed to be greater than the outer diameter of the first screw 120a in this embodiment. When the first rack 110a pivots relative to the second rack 110b, the first screw 120a can move along the second opening 114, such that the entire structure has sufficient degrees of freedom in movement.

Under said arrangement, the first elastic member 150a pushes the first rack 110a against the first rotary knob 130a and pushes the second rack 110b against the first pin 140a, so as to fix the relative angle of the first and second racks 110a and 110b. When the angle at which the projector 50 is placed is to be adjusted, the first rotary knob 130a can be rotated to move along the direction D1 or D2 on the first screw 120a, such that the first rack 110a is driven to compress the first elastic member 150a and pivots relative to the second rack 110b, or the compressed first elastic member 150a releases the resilient potential energy to pivot the first rack 110a relative to the second rack 110b, so as to adjust the angle at which the projector 50 fixed to the first rack 110a is placed.

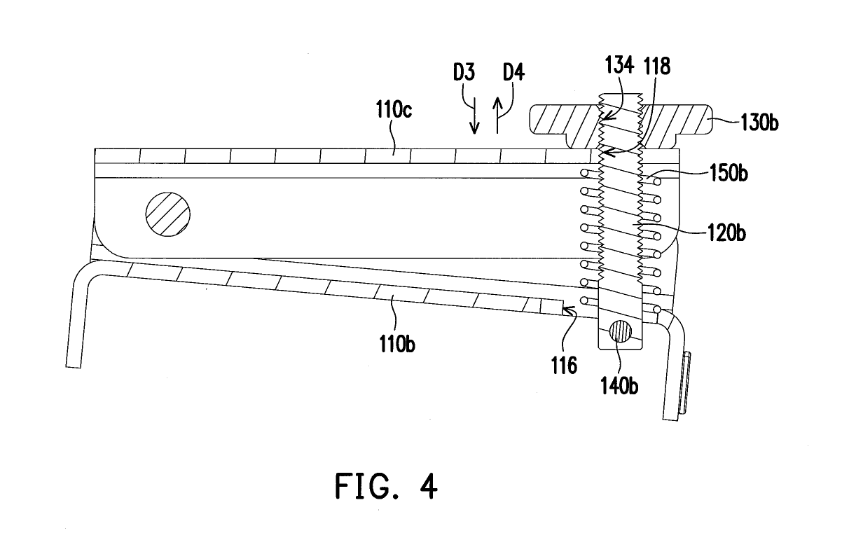

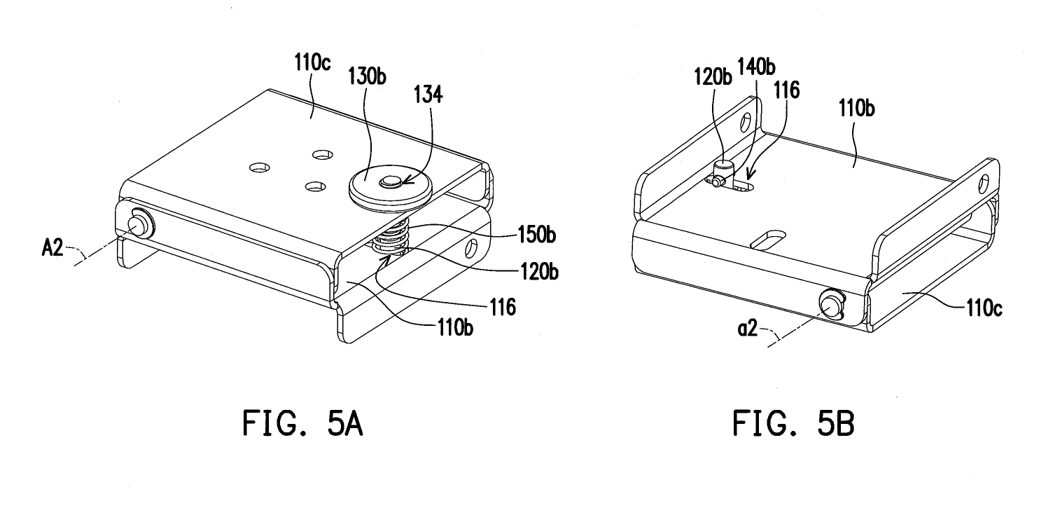

FIG. 4 is a cross-sectional view illustrating some components in the adjustment module depicted in FIG. 1. FIG. 5A is a three-dimensional view illustrating that the third rack depicted in FIG. 1 pivots relative to the second rack. FIG. 5B is a three-dimensional view illustrating that the third rack depicted in FIG. 1 pivots relative to the second rack from another viewing angle. With reference to FIG. 1, FIG. 4, FIG. 5A, and FIG. 5B, the adjustment module 100 of this embodiment further includes a third rack 110c, a second screw 120b, a second rotary knob 130b, a second pin 140b, and a second elastic member 150b. The third rack 110c is pivotally connected to the second rack 110b along a second axis A2 that is perpendicular to the first axis A1. The second rack 110b further has a third opening 116, and the third rack 110c has a fourth opening 118.

The second screw 120b is configured between the second rack 110b and the third rack 110c. The second rotary knob 130b has a second threaded hole 134. One end of the second screw 120b passes through the fourth opening 118 and is screwed into the second threaded hole 134. The other end of the second screw 120b passes through the third opening 116 and is fixed to the second pin 140b. The second rack 110b and the third rack 110c are located between the second rotary knob 130b and the second pin 140b. The second elastic member 150b is configured between the second rack 110b and the third rack 110c. Besides, the second elastic member 150b pushes the second rack 110b against the second pin 140b and pushes the third rack 110c against the second rotary knob 130b. Moreover, in this embodiment, the second elastic member 150b is, for example, a compression spring and the second screw 120b passes through the compression spring.

When the second rotary knob 130b rotates and moves toward the second rack 110b along the second screw 120b, i.e., moves along the direction D3 shown in FIG. 4, the third rack 110c is driven to resist a resilient force of the second elastic member 150b and pivots relative to the second rack 110b, such that the relative angle of the second rack 110b and third racks 110c is shown from the position of FIG. 1 and FIG. 4 to the position of FIG. 5A and FIG. 5B. When the second rotary knob 130b rotates and moves away from the second rack 110b along the second screw 120b, i.e., moves along the direction D4 shown in FIG. 4, the second elastic member 150b releases the resilient potential energy and pushes the third rack 110c to pivot relative to the second rack 110b, such that the relative angle of the second rack 110b and third rack 110c is shown from the position of FIG. 1 and FIG. 4 to the position of FIG. 5A and FIG. 5B. The length of the third opening 116 is designed to be greater than the outer diameter of the second screw 120b in this embodiment. When the third rack 110c pivots relative to the second rack 110b, the second screw 120b can move along the third opening 116, such that the entire structure has sufficient degrees of freedom in movement.

Under said arrangement, the second elastic member 150b pushes the third rack 110c against the second rotary knob 130b and pushes the second rack 110b against the second pin 140b, so as to fix the relative angle of the second rack 110b and the third rack 110c. When the angle at which the projector 50 is placed is to be adjusted, the second rotary knob 130b can be rotated to move along the direction D3 or D4 on the second screw 120b, such that the third rack 110c is driven to compress the second elastic member 150b and pivots relative to the second rack 110b, or the compressed second elastic member 150b releases the resilient potential energy to pivot the third rack 110c relative to the second rack 110b. Thereby, the angle at which the projector 50 is placed can be adjusted easily.

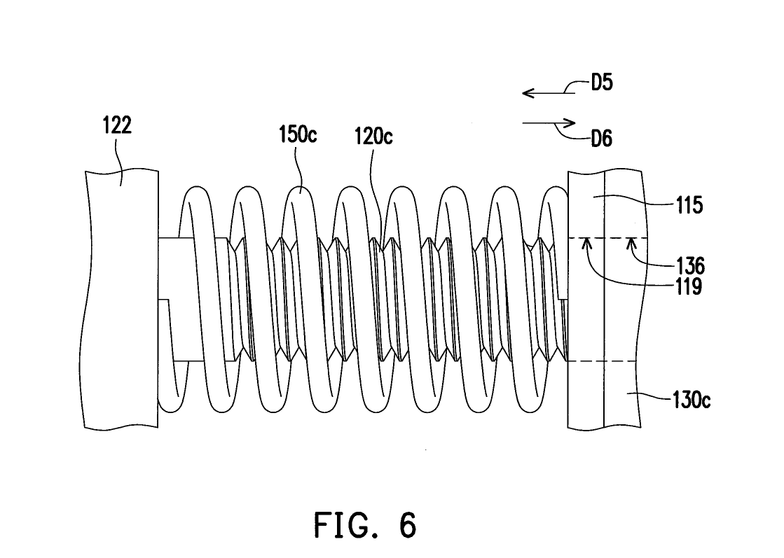

FIG. 6 is a partial side view illustrating the adjustment module in FIG. 1. With reference to FIG. 1 and FIG. 6, the adjustment module 100 of this embodiment further includes a fourth rack 110d, a third rotary knob 130c, a third screw 120c, a third pin 140c, and a third elastic member 150c. The fourth rack 110d is suitable for being fixed to a fixing end, e.g., a ceiling Besides, the fourth rack 110d includes a main body 113 and a side board 115. The main body 113 is pivotally connected to the third rack 110c along a third axis A3 that is perpendicular to the first axis Al and the second axis A2. The side board 115 is connected to the main body 113 and is perpendicular to the main body 113. Additionally, the side board 115 has a fifth opening 119. The third rotary knob 130c has a third threaded hole 136.

One end of the third screw 120c passes through the fifth opening 119 and is screwed into the third threaded hole 136. The other end of the third screw 120c has a restraining portion 122 and a pivoting hole 124. The side board 115 of the fourth rack 110d is located between the third rotary knob 130c and the restraining portion 122. The third pin 140c is fixed to the third rack 110c and is pivotally connected to the pivoting hole 124 along a fourth axis A4 that is parallel to the third axis A3. The third elastic member 150c (shown in FIG. 6) is configured between the side board 115 of the fourth rack 110d and the restraining portion 122. Besides, the third elastic member 150c pushes the fourth rack 110d against the third rotary knob 130c and the restraining portion 122. Moreover, in this embodiment, the third elastic member 150c is, for example, a compression spring and the third screw 120c passes through the compression spring.

When the third rotary knob 130c rotates and moves toward the restraining portion 122 along the third screw 120c, i.e., moves along the direction D5 shown in FIG. 6, the fourth rack 110d is driven to resist the resilient force of the third elastic member 150c and pivots relative to the third rack 110c. By contrast, when the third rotary knob 130c rotates and moves away from the restraining portion 122 along the third screw 120c, i.e., moves along the direction D6 shown in FIG. 6, the third elastic member 150c releases the resilient potential energy and pushes the third pin 140c to pivot the third rack 110c relative to the fourth rack 110d.

Under said arrangement, the third elastic member 150c pushes the side board 115 against the third rotary knob 130c and the restraining portion 122, so as to fix the relative angle of the third rack 110c and the fourth rack 110d. When the angle at which the projector 50 is placed is to be adjusted, the third rotary knob 130c can be rotated to move along the direction D5 or D6 on the third screw 120c, such that the third elastic member 150c is compressed and the third pin 140c is pushed to pivot the third rack 110c relative to the fourth rack 110d, or the compressed third elastic member 150c releases the resilient potential energy to pivot the third rack 110c relative to the fourth rack 110d, so as to adjust the angle at which the projector 50 is placed.

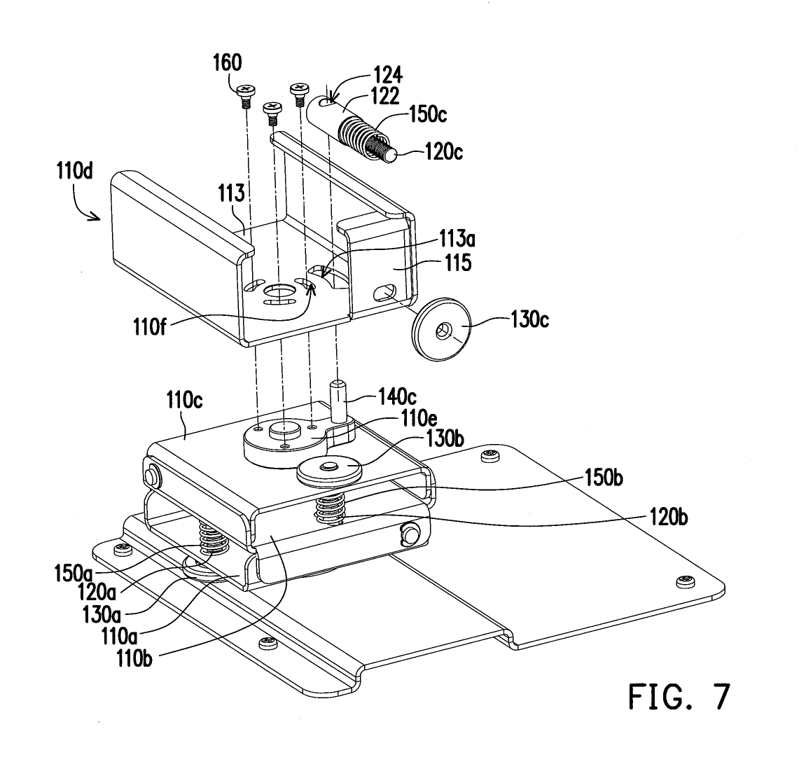

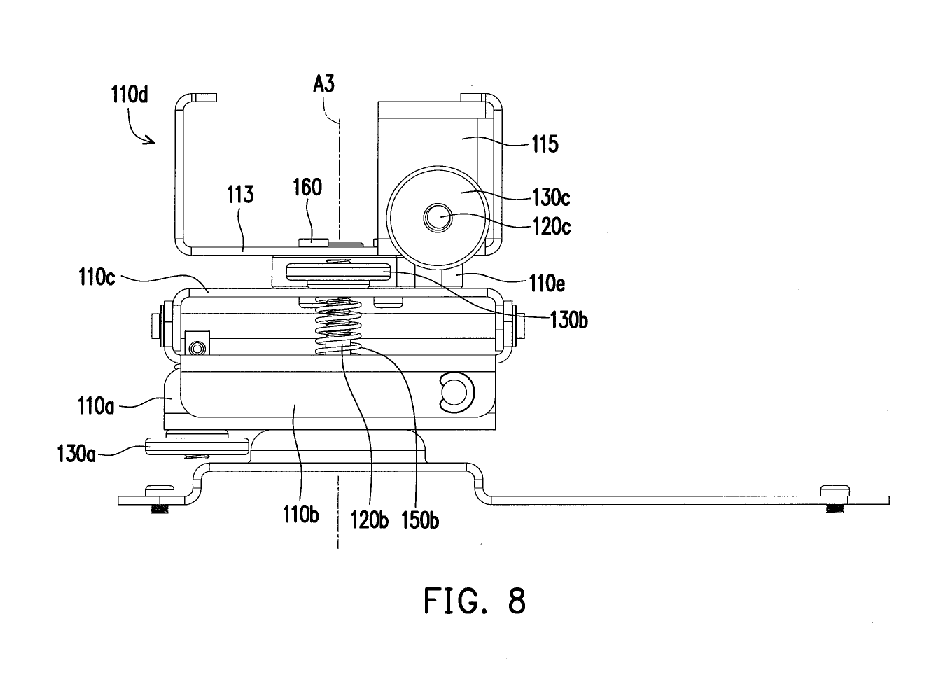

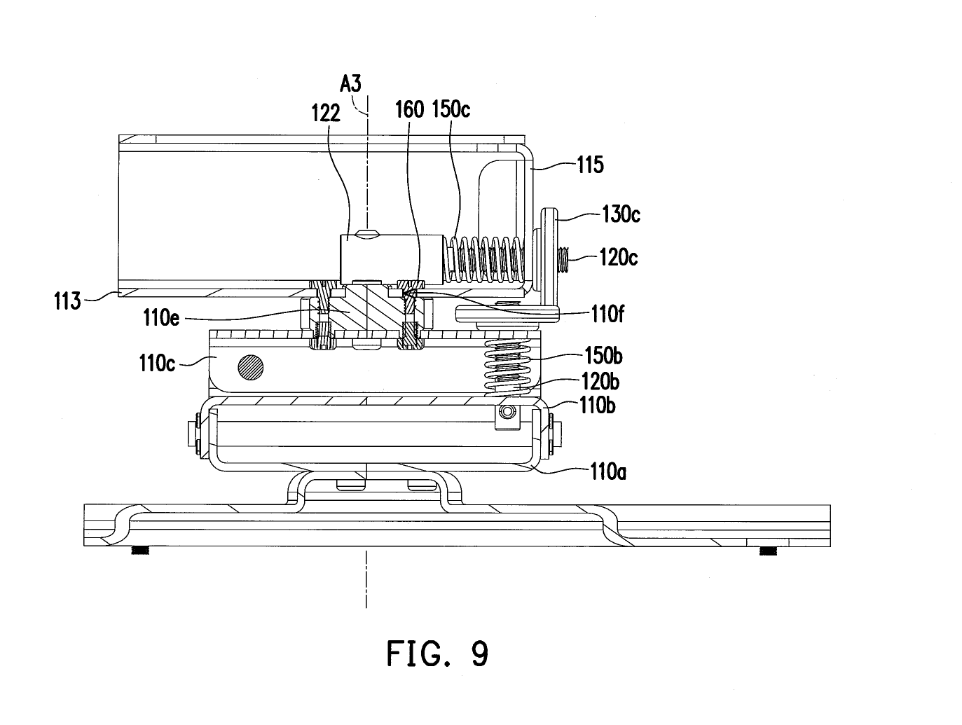

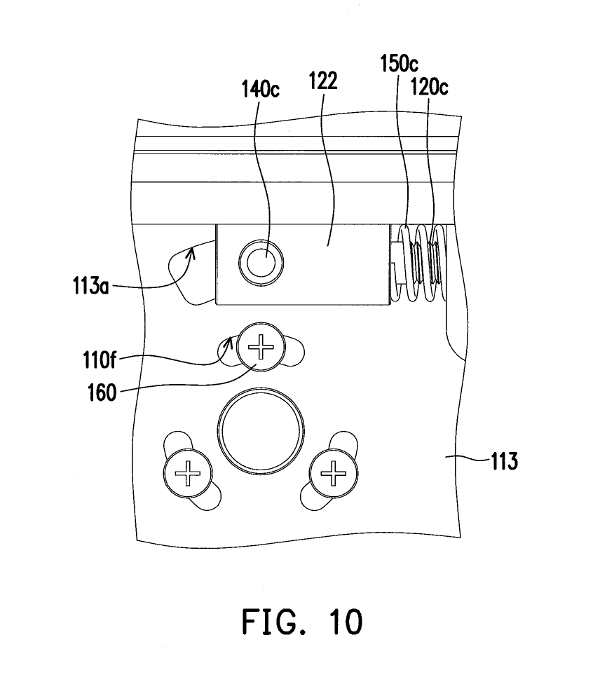

FIG. 7 is an explosive view illustrating partial components of the adjustment module depicted in FIG. 1. FIG. 8 is a side view illustrating the adjustment module depicted in FIG. 1. FIG. 9 is a cross-sectional view illustrating the adjustment module depicted in FIG. 1. FIG. 10 is a partial top view illustrating the adjustment module depicted in FIG. 1. With reference to FIG. 7 to FIG. 10, to be more specific, the third rack 110c of this embodiment has a pivoting portion 110e. The main body 113 is pivotally connected to the pivoting portion 110e along the third axis A3 and has at least one sliding slot 110f (three sliding slots 110f are shown in the drawings). The adjustment module 100 further includes at least one locking member 160 (three locking members 160 are shown in the drawings). The locking members 160 respectively pass through the sliding slots 110f and are locked to the pivoting portion 110e, such that the fourth rack 110d is restrained by the pivoting portion 110e. When the main body 113 rotates relative to the pivoting portion 110e along the third axis A3, the locking members 160 moves along the sliding slots 110f, such that the entire structure has sufficient degrees of freedom in movement. Besides, the main body 113 has a sixth opening 113a. One end of the third pin 140c passes through the sixth opening 113a and is pivotally connected to the pivoting hole 124. The length of the sixth opening 113a is designed to be greater than the outer diameter of the third pin 140c. When the third rack 110c pivots relative to the fourth rack 110d, the third pin 140c can move along the sixth opening 113a, such that the entire structure has sufficient degrees of freedom in movement. The first rotary knob 120a, the second rotary knob 120b, or the third rotary knob 120c in the adjustment module 100 shown in FIG. 1 can be rotated, such that the angle at which the projector 50 is placed can be adjusted independently along the first axis A1, the second axis A2, or the third axis A3.

According to the previous embodiments of the invention, the first elastic member pushes the first rack against the first rotary knob and pushes the second rack against the first pin, so as to fix the relative angle of the first and second racks. The second elastic member pushes the third rack against the second rotary knob and pushes the second rack against the second pin, so as to fix the relative angle of the second and third racks. The third elastic member pushes the fourth rack against the third rotary knob and the restraining portion, so as to fix the relative angle of the third and fourth racks. When the angle at which the projector is placed is to be adjusted, the first rotary knob, the second rotary knob, or the third rotary knob can be rotated, so as to adjust the angle at which the projector is placed independently along the first axis, the second axis, or the third axis.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims. Moreover, these claims may refer to use “first”, “second”, etc. following with noun or element. Such terms should be understood as a nomenclature and should not be construed as giving the limitation on the number of the elements modified by such nomenclature unless specific number has been given.

What is claimed is:

1. An adjustment module adapted to a projector, the adjustment module comprising:
a first rack suitable for being fixed to the projector, the first rack having a first opening;
a second rack pivotally connected to the first rack along a first axis, the second rack having a second opening;
a first screw configured between the first rack and the second rack;
a first rotary knob having a first threaded hole, wherein one end of the first screw passes through the first opening and is screwed into the first threaded hole;
a first pin, wherein the other end of the first screw passes through the second opening and is fixed to the first pin, and the first rack and the second rack are disposed between the first rotary knob and the first pin; and
a first elastic member configured between the first rack and the second rack, wherein the first elastic member pushes the first rack against the first rotary knob and pushes the second rack against the first pin.

2. The adjustment module as claimed in claim 1, wherein the first elastic member is a compression spring, and the first screw passes through the compression spring.

3. The adjustment module as claimed in claim 1, wherein a length of the second opening is greater than an outer diameter of the first screw, and the first screw moves along the second opening when the first rack pivots relative to the second rack.

4. The adjustment module as claimed in claim 1, further comprising:
a third rack pivotally connected to the second rack along a second axis perpendicular to the first axis, wherein the second rack further has a third opening, and the third rack has a fourth opening;
a second screw configured between the second rack and the third rack;
a second rotary knob having a second threaded hole, wherein one end of the second screw passes through the fourth opening and is screwed into the second threaded hole;
a second pin, wherein the other end of second screw passes through the third opening and is fixed to the second pin, and the second rack and the third rack are disposed between the second rotary knob and the second pin; and
a second elastic member configured between the second rack and the third rack, wherein the second elastic member pushes the second rack against the second pin and pushes the third rack against the second rotary knob.

5. The adjustment module as claimed in claim 4, wherein the second elastic member is a compression spring, and the second screw passes through the compression spring.

6. The adjustment module as claimed in claim 4, wherein a length of the third opening is greater than an outer diameter of the second screw, and the second screw moves along the third opening when the third rack pivots relative to the second rack.

7. The adjustment module as claimed in claim 4, further comprising:
a fourth rack pivotally connected to the third rack along a third axis perpendicular to the first axis and the second axis, wherein the fourth rack has a fifth opening and is suitable for being fixed to a fixing end;
a third rotary knob having a third threaded hole;
a third screw, wherein one end of the third screw passes through the fifth opening and is screwed into the third threaded hole, the other end of the third screw has a restraining portion and a pivoting hole, and the fourth rack is disposed between the third rotary knob and the restraining portion;
a third pin fixed to the third rack and pivotally connected to the pivoting hole; and
a third elastic member configured between the fourth rack and the restraining portion.

8. The adjustment module as claimed in claim 7, wherein the third elastic member is a compression spring, and the third screw passes through the compression spring.

9. The adjustment module as claimed in claim 7, the fourth rack comprising:
a main body pivotally connected to the third rack along the third axis; and
a side board connected to the main body, the side board being perpendicular to the main body, the fifth opening being formed at the side board, the side board being disposed between the third rotary knob and the restraining portion, the third elastic member being configured between the side board and the restraining portion.

10. The adjustment module as claimed in claim 9, wherein the main body has a sixth opening, one end of the third pin passes through the sixth opening and is pivotally connected to the pivoting hole, a length of the sixth opening is greater than an outer diameter of the third pin, and the third pin moves along the sixth opening when the fourth rack pivots relative to the third rack.

11. The adjustment module as claimed in claim 9, wherein the third rack has a pivoting portion, and the main body is pivotally connected to the pivoting portion along the third axis and has at least one sliding slot, the adjustment module further comprising at least one locking member passing through the at least one sliding slot, the at least one locking member being locked to the pivoting portion, the at least one locking member moving along the at least one sliding slot when the main body rotates relative to the pivoting portion along the third axis.

12. The adjustment module as claimed in claim 7, wherein the third pin is pivotally connected to the pivoting hole along a fourth axis, and the fourth axis is parallel to the third axis.
